(19) United States
(12) Patent Application Publication
(10) Pub. No.: US 2004/0199412 A1
(43) Pub. Date: Oct. 7, 2004

(54) INTERNET-BASED SCHEDULING METHOD AND SYSTEM FOR SERVICE PROVIDERS AND USERS

(76) Inventor: Stephen F. McCauley, Arlington, TX (US)

Correspondence Address: MALIN HALEY AND DIMAGGIO, PA, 1936 S ANDREWS AVENUE, FORT LAUDERDALE, FL, 33316, US

(21) Appl. No.: 10/249,085

(22) Filed: Mar. 14, 2003

(51) Int. Cl. G06F 17/60

(52) U.S. Cl. 705/7; 705/8

(57) ABSTRACT

A Consumer/service Provider internet scheduling system and method that is an internet integrated Consumer driven system for most efficiently matching a Consumer/client/patient via the internet with a specific or varied service Providers (who publicize “openings” in their schedule) in a desirable geographical area relative to the user that also includes selection of criteria discriminators including first available, closest in distance, price information, Provider gender, experience, education background, and other important consumer desired requirements. Consumers offer database reference information which includes email address, phone number, address, Health insurance plan. Organ donor status, and other useful information which can be automatically and efficiently used on subsequent visits. Providers can be give special recommendations or critiques following service for future Consumer pool reference. In all, the device is a program which pairs Consumers with Providers to mutual benefit.

### BACKGROUND OF INVENTION

1. Field of the Invention

This invention relates generally to an internet-based and/or software based method and system for Consumer scheduling, by time, of service Provider appointments for a plurality and assortment of users seeking specific services in a geographical area, and specifically, to an interactive internet-based method and system that allows users seeking specific services to be performed to find, select and schedule time-sensitive appointments from a list of service Providers based upon desirable service. Provider attributes are selected by the Consumer such as first available appointment, distance and price, and other variables. Service Providers can include doctors, lawyers, dentists, auto and home repair specialists, veterinarians, and other appointment oriented service or businesses.

2. Description of Related Art

Every day, millions of Consumers attempt to schedule appointments with service Providers, especially in the healthcare or home service sector. Most specific service Providers such as doctors, lawyers, dentists, repairmen, and veterinarians require a specific appointment time. The dilemma for the Consumer and or user is to try and find a reasonably priced, readily available service Provider within a reasonable or given time period. Typically, the user would employ a business telephone directory (i.e. “yellow pages”) and search through pages of advertisements of the various service Providers based on their names as listed in the telephone directory. Often, after random selection, the next user step would be to attempt to schedule an appointment by telephone. Quite often (especially with respect to a doctor's office), it is difficult to even find the time available to talk to a receptionist on the telephone. Once a “live” person is engaged, the next Consumer problem is selecting a reasonably scheduled time, which can often be months away with respect to some doctors and dentists, or other “high demand” service areas.

Another problem, from a Consumer”s standpoint, is the selection of a service Provider based strictly on a telephone directory advertisement without obtaining any real substantive information concerning the availability, experience, experience level, location, and price of a service Provider.

From a user's standpoint, the current system and method of using the telephone and a telephone business directory for scheduling service appointments is very frustrating, costly in delays, and extremely inefficient in oral discourse.

However, it is equally challenging for service Providers (both professional and laborers) to maintain a continuously filled calendar because of last minute “no-shows” or cancelled appointments all of which can result in loss of revenue. Service Providers require extra personnel (more overhead) who are devoted solely to scheduling and confirming appointments. Additional staff time (that is very costly) is required to gather and obtain initial and current information from a user. Thus, from both user and service Providers' standpoints, the scheduling of user appointments is costly and inefficient for all concerned.

The purpose of the present invention is to solve such service Provider scheduling problems to produce an efficient, interactive scheduling system and method beneficial for both user and professional service Provider within a single or multiple geographical area using the internet.

### SUMMARY OF INVENTION

An internet-based method and system for finding, selecting and scheduling user time appointments for a plurality or specific group of users seeking myriad or defined services and service Providers in a geographical area accessible by the user.

The system and method to employ a scheduling Host having a web site accessible on the internet by the using Consumer and the service Provider. The scheduling Host web site is produced on a central Host Server to include scheduling application programs, home page, a scheduling database including service Provider data and various web pages that include numerous menus and selections described below.

A database associated with one or more scheduling Host Servers stores service Provider profiles and unique calendar information which displays open time slots of availability for every service Provider in a geographical area. The user/Consumer requires a personal computer (PC) having internet access for viewing the scheduling Host website containing said service Provider database for selecting a service Provider and requesting an appointment during a specified “open time slot” designated as available from a service Provider. The service Provider requires a PC with internet access to label “accepted” or “rejected” or “pending” back to a consumer the requested appointment (also, approved or disapproved by insurance.) This information is only displayed on Consumer and Provider PCs.

The user PC must include an internet service provider (ISP)(and a suitable browser) for accessing the internet; and have access to the specific scheduling Host Server website set up by the schedule manager. The Host manager Server PC maintained by scheduler Host manager includes an extensive data base of services of Providers listed on the Host scheduler web site.

Each service Provider may be registered and shall provide business information to the Host Server scheduler manager for the reference data base. Access to the calendar by the service Provider is provided by the Provider”s office manager to interactively create and edit display of open slot appointment availability of appointment times available to the consumer for several months in advance.

Once a specific service Provider”s time slot on the office manager's calendar has been requested by a user, accessing the office schedule manager's web site, the user selection is entered into the service Provider”s calendar open time slot as a “Request.” Otherwise, should the requested appointment slot not be open, Consumer may elect to be placed on the “wait list”, or “first opening” category for that Provider. The service Provider must from time to time, periodically, or continuously monitor the service Provider”s own calendar using the service Provider”s PC or other access portal. The service Provider then accesses through the office schedule manager calendar and decides upon accepting the appointment time or rejecting the appointment time for the user, which is now displayed as “accepted” or “pending” or “not accepted” on the web site scheduling calendar time slot. The service Provider may also send an email acceptance or non-acceptance directly to the user to the user's email address, or request additional information.

The main scheduling Server contains a data base which identifies service Providers' information such as specific services provided, location, phone, and address (distance) of the service Provider and other information of relevance. Only the open time slots made “available” from the service Provider, relative pricing information (optional) and, perhaps, additional information about the experience level, gender, and special technical skills of the service Provider. The Host Server provides one or more scheduling application programs, to include several menus accessible by a Consumer to display numerous variables desired to aid in finding and selecting a specific service Provider at a specific time slot. For example, the user can select “first available” as to first available time slot for a particular service (at large), distance as to closest service Provider, or other variables of special interest to the user/(Consumer) in the selection of the actual service Provider.

To implement the system, the Consumer PC, the service Provider PC, and the (scheduler manager) Server are connected by ISPs and browsers through the internet as the basis of interactive communication. The Host (scheduler manager) Server web site contains all information pertaining to the service Provider; including calendar open slots and specific services offered. Access to control each individual service Provider”s calendar is through passwords used by the service Provider and Consumer to view and manipulate the calendar. Typically, the principal calendar information available to the user is the service Provider”s open appointment time slots. The entire schedule of the service Provider is not displayed or made available over the “world wide-web.” Security can be established to comply with the Health Insurance Portability and Accountability Act (HIPAA).

When a request is made by a user requesting a specific appointment with a specific service Provider, additional user information may be required; such as the identity of the user's health insurance company or requests for user's method of payment. HIPAA information for healthcare Providers is available. A link (via internet site, email, or telecon) to the identified insurance company from the service Provider can identify instantaneously whether or not the user is covered by a particular insurance policy.

In an alternate embodiment, this system and method can be used even if the user does not even own or have access to a personal computer or the internet (through-a modem or other type of internet access transmission line.) In that case, the Consumer can dial a pre-determined phone number and access an operator that does have a PC access into the scheduler manager (Host) Server web site, and can obtain interactively information from the user to find and select a particular service Provider and time slot for an appointment.

The service Provider can monitor in real time its own calendar and all requests received from potential user, both potential customers or existing Patients/Consumers either through a PC screen display provided to the service Provider from the (scheduler manager) Server web-site including the specific user request received and the e-mail address of the user/Consumer requester.

Additional service Provider information (including advertisements) can be preloaded by links to other scheduler manager web pages on manager Server or linked to other web sites that users can view. This can be an additional link to a specific service Provider with much more information about the service Provider. This gives a service Provider direct access to its own personalized web-site.

Time slots subject to cancelled appointments of the service Provider can be readily reopened to users/Consumers and made available to users accessing the calendar of the service Provider. The scheduling system can also provide a “wait list” of potential users awaiting appointments for quick response if an opening becomes available through cancellation through the service Provider.

The user (Consumer) information can be prepared and sent by the user (Consumer) from the user's own home PC and automatically forwarded to a service Provider to save time. Credit card and financial information from the user can be made at the time of making an appointment. E-mail confirmation from the service Provider can be sent to a user that the appointment is confirmed.

It is an object of this invention to provide an improved interactive (internet-based) scheduling calendar for use by Consumers/Patients for matching specific service Providers within a geographical area, and to expedite selection of time slots that are available by a service Provider to a user (Consumer/Patient.)

It is another object of this invention to serve as a repository to rapidly access information regarding organ-donor status, eye bank, blood types, (confidential HIV status) and myriad other derivatives to better serve the community.

Yet another object of this invention is to provide an improved scheduling system and method for users, Consumers, patients for matching service Providers including medical personnel, home repairmen, or any Providers of services that can be interactively be selected over the internet through a (Host scheduler) Server. This includes selecting scheduling choices by the user of first available service Provider, closest in distance, most experienced or best price or other criteria of interest.

But yet still another object of this invention is to provide a internet-based, access scheduling calendar for users/Consumers/patients to find and select service Providers that permit rapid interaction for request and approval of service Provider appointments. At the same time, this system provides user information to the service Provider for expediting the appointment scheduling process and to determine whether the user patient/Consumer meets service Provider criterion. Thus, this service is intended a true Consumer to Provider (C to B) system. Additionally, this “scheduling function” and “wait list” truly afford all participants a useful mechanism for tracking personal schedule requirements.

In accordance with these and other objects which will become apparent hereinafter, the instant invention will now be described with particular reference to the accompanying drawings.

### BRIEF DESCRIPTION OF DRAWINGS

FIG. 1 is a schematic diagram showing the present invention.

FIG. 2 is a schematic diagram showing the operation of the present invention.

FIG. 3 shows a “screen shot” menu for a user to select some variables available using the present invention on the display screen.

FIG. 4 shows the typical “screen shot” calendar display screen for selecting day of the month by a user.

FIG. 5 shows a displayed time slot availability “screen shot” for selecting an appointment by a user in the present invention.

### DETAILED DESCRIPTION

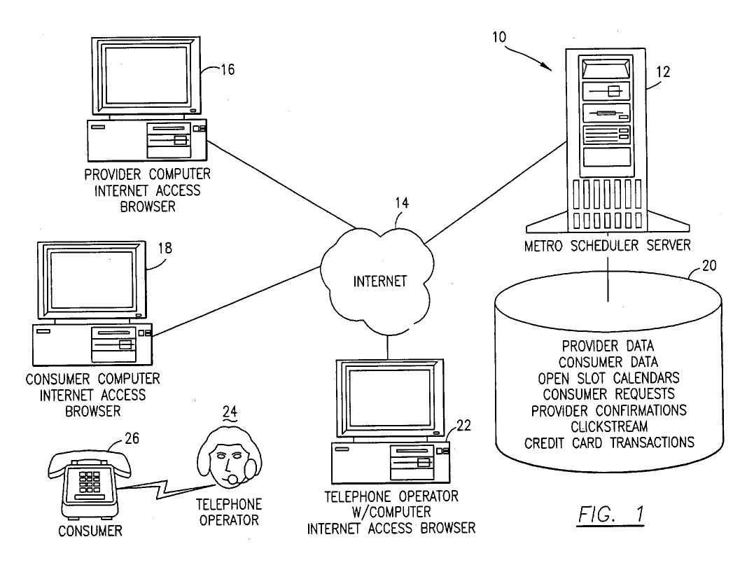

Referring now to the drawings and, in particular, FIG. 1, the present invention is shown generally indicated by 10 that includes a scheduler manager Server 12 which is a large “server-computer” with a data base, a internet communication set up 14 that connects Server 12 to a service Provider computer 16 through the internet 14 and a user personal computer PC 18.

The system can also use telephone access by a user/Consumer/Patient that includes a PC 22 connected to the internet that includes a live operator 24 that has a telephone that can be called by a Consumer phone 26. The scheduling system shown in FIG. 1 includes a data base 20 maintained in the scheduler Server 12 that has service Provider data, Consumer data, a calendar for each service Provider, open slot calendar dates for service Providers that are available, Consumer requests, service Provider confirmations, credit card transactions and other relevant data in the process of matching a user or Consumer with a service Provider. The application programs allow for numerous activities described herein by both the user and the service Provider in matching for services available. “C2B” corporate “Metroscheduler” structure is currently established with two distinct bodies beneath. Metroscheduler Concept: “Health Scheduler.Net (+.com) and Service Scheduler.Net(.com).

The system shown provides for a fully automated and integrated Consumer driven system and method for most efficiently matching a user such as a client, customer, or patient with a service Provider that is available in a timely manner to meet the user's desired appointment requirements including unique constraints. The user has a computer such as a PC 18 that has an internet access browser and utilizes an internet service Provider (ISP) that by accessing internet 14 can arrive at a home web page maintained by the scheduler manager in the scheduler manager Server 12. The Server 12 includes, among other things, in its web page a list of service categories and available service Providers in the area that can be reviewed and selected by the user through the user's PC 18. A discreet calendar for each service Provider is maintained. Specifically, each service Provider data base calendar maintained in Server 12 includes only one or more open time slots in a monthly, daily, and hourly/minute calendar display that is available for a user. Thus, one of the important elements of the system is that the method and system offer users and Consumers discreet visibility into applicable times available in any service Provider”s schedule to efficiently find appointments or openings while at the same allowing service Providers to efficiently fill appointment openings. The scheduler manager Server 12 data base Hosts thousands of individual service Provider open slot appointment availabilities and only reveals open slots made available by the service Provider which is maintained by the service Provider office through the service Provider PC 16. The service Provider also would have a personal computer 16 and an internet access browser and an internet service Provider to allow interactive internet access by the service Provider to the scheduler Host Server 12. Typically, the service Provider would require a password that allows the service Provider to alter and change the calendar open time slots schedule maintained in the data base in the Host Server 12 and to accept or reject a specific user request that is specific to the service Provider.

The application computer programs maintained in the scheduler manager Server 12 also include a list of criteria that allows the user to sort by “first available” appointment, sort by “distance” from the user, to “sort by cost” or any other particular desirable constraints which may be used in the system. (As many as necessary discriminators)

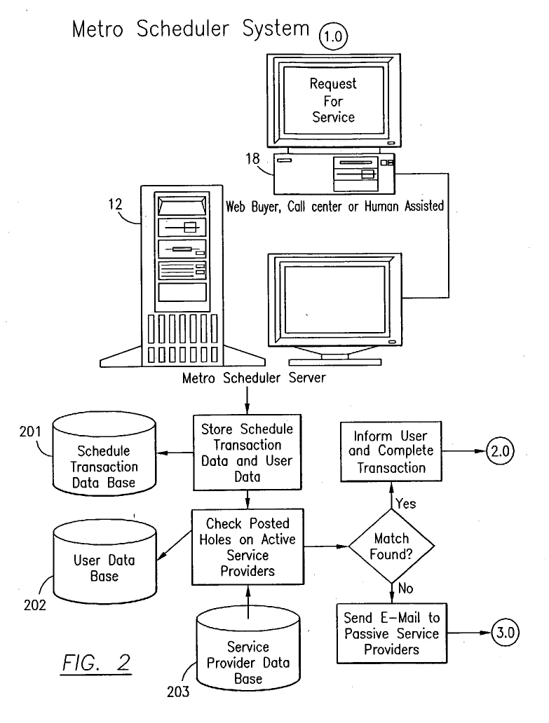

Referring now to FIG. 2, the scheduler manager Server 12 and data base is maintained by a scheduler manager that provides the application software, maintains the website and provides the scheduling service through the use of a find, select and schedule a service Provider software program that is interactive between all the service Providers in a metropolitan or rural area and the millions of users in the same areas that require services. For the sake of the discussion of the invention, the party that maintains the scheduler manager Server 12 will be called the scheduler manager. The scheduler manager web site or home web page is the address that would be used by both a user from a personal computer 18 that is connected to the scheduler Server and a service Provider. The scheduler manager Server 12 provides for storing the schedule transaction data and the user data from the scheduled transaction data base 201. From the stored schedule or calendar of service Providers, the system can check posted slots or holds on active service Providers that are maintained in the data base. A user data base 202 is provided along with the service Provider data base 203. A wait list for users is also maintained, as well as organ donor status and medical trials “alerts/notifications”.

In a transaction, the user PC 18 is used by a user through the internet looking for services or for a specific service Provider by accessing the home page maintained in the Server 12. By using a plurality of display menus maintained on the home page of the scheduler Server 12, a plurality of menus are made available to the user which are discussed below to find and select a specific service Provider. Once that is done, that specific service Provider”s calendar which shows only open holes or slots of time available by month, by day, hour and minutes are then provided to the user. The user selects a specific time slot of a specific service Provider and interactively (using the PC) requests an appointment electronically by clicking on that open time slot. The scheduler Server data base then provides for a match found and sends an email to the service Provider”s personal computer 16 (FIG. 1) notifying the service Provider that there is a user desiring a specific available time slot. The service Provider”s PC display will then indicate such and the service Provider (whoever is maintaining the PC) can then notify the user through to scheduler Server display on the calendar that the appointment is accepted. This is sent back to the scheduler Server as a completion. The user can access the scheduler Server to learn of the acceptance. The service Provider can also send an email to the user that the transaction is complete.

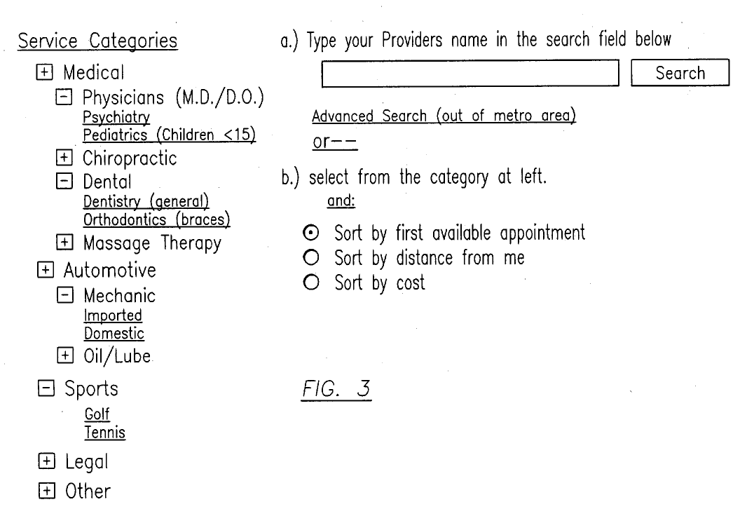

Referring now to FIG. 3, one of the menus maintained by the scheduler manager Server that is displayed to a user provides for service categories to be selected by the user. The menu also allows the user to select, as an alternative, a category that is sorted by first available appointment, by distance from the user or sorted by costs, so that once the category is selected, the user would then click on the particular type of service category available and obtain a list of potential service Providers based on the category selected.

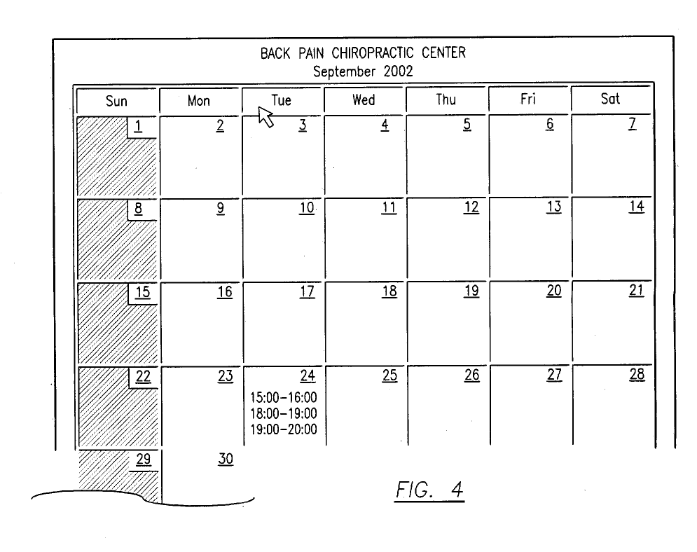

Once a service Provider is selected by the user, the menu in FIG. 4 shows a typical calendar display provided to the user from the scheduler manager Server that is specific to a particular service Provider. Various indica are used on days of the month to indicate a number of open time slots for a particular day of the month.

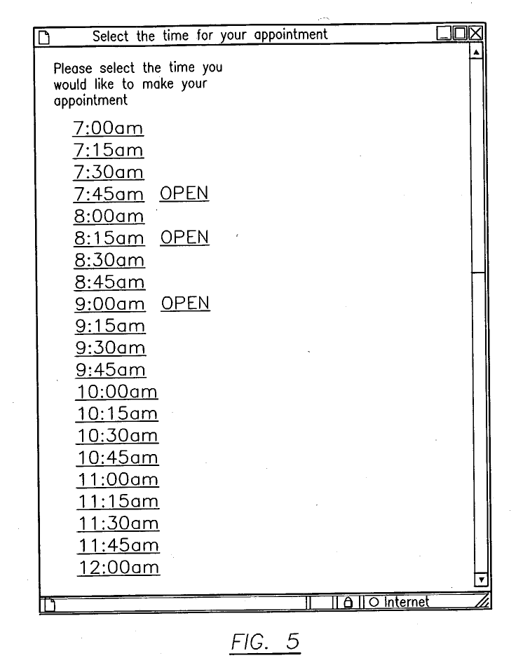

These time slots are specific to a single service Provider. The user clicks on that day of the month and obtains a second different menu display that is shown in FIG. 5.

FIG. 5 shows a typical display of time in segments of fifteen minutes from 6:00 a.m. to 12:00 p.m. that says please select the time slot you would like to make your appointment. Note there are no other entries filled in, but there are only the words “open” in front of 7:45 a.m., 8:15 a.m. and 9:00 a.m. These open slots indicate that there are only three open periods for fifteen minutes available to the user. At that point, the user could reject the times available and go back to the calendar menu shown in FIG. 4 or click on “open” at a particular time, thereby requesting an appointment in that specific time slot for a specific day of the month.

When the user first initially contacts the scheduler manager home web page, the user is asked to register in the scheduling network. Thus, a user would have to have a name, perhaps a password, an email address, other information such as phone numbers, addresses, city, state, zip code and, if medical is involved, it could require the names of medical insurance companies, member numbers and also credit cards.

Thus, the scheduler manager”s Server data base accumulates an initial information list about the user which will be useful in determining other data-base information and passing this information on to a service Provider to save much time at the service Provider”s end. Services could even be paid for in advance, prior to the appointment being scheduled by the user through this method and system.

During the transaction process, once a particular service Provider has been selected by clicking on an open time slot in the schedule calendar shown in FIG. 5, the reply from the service Provider is done in response to the appointment schedule that the service Provider received the user information giving their name, address and email, the requested appointment date and time and that the service Provider is reviewing the user request and will notify the user quickly as to the availability of the appointment. Once the service Provider approves the specific appointment time of the user, then the service Provider interacts and clicks on the time slot to the scheduler manager Server approving the appointment. Additionally/optionally a direct email to the user may be sent saying that the appointment is approved. If the user is not online at the time, then the user can at a later time go online and would see an email or calendar update from the service Provider approving the appointment time and schedule. During the same transaction, the service Provider could request additional medical information concerning the user, the health insurance number and even a credit card number, if necessary, and other additional information that does not have to be logged in at the time of the appointment by the user.

By using the method and system provided herein, a very cost effective method for finding, selecting, scheduling, coordinating, validating and confirming Consumer appointments are provided primarily using the internet. If the internet is not available, a telephone network can be used through an operator that also uses the internet make the appointment for a user on the telephone, getting the same information. Within a geographical area such as a metropolitan city area, the users can access all the service Providers within a reasonable distance from the service Providers home or even seek special services that may be even in a city farther away.

From the service Provider”s standpoint, the present invention greatly cuts down unnecessary time and extra people necessary for answering telephones and constantly calling users back and forth trying to establish appointments. It also saves a lot of time by registering each initial patient that needs a service, by allowing the service Provider to obtain total useful information concerning the user electronically without having to have additional personnel record the data.

One of the great benefits to the user is the ability to have a huge data base full of service Providers available in a particular area that can be selected by first available, by distance, by cost or other variables that can be used in the system that would be desired criteria for use by Consumers, user, patients and the like.

Another benefit to the service Provider is that if appointments are cancelled (which often can be weeks in advance, or the day before an appointment) someone accessing and requiring a service Provider can be notified immediately that there is an open slot available according to the system. Finally the system can use live operators for people who are not able to have access to a computer that can access the internet. However, the service Providers still have the ability to make open slot appointments by using the scheduling system provided herein wherein the scheduler manager would provide live operators.

The system can also provide reminder functions by sending emails the day before the appointment or several days in advance as a reminder to the user. A wait list can be established by a user on a specific service Provider so that when an open slot becomes available the system would automatically obtain the request from the user in a new available time slot. The system can be used, of course, with wireless personal computers and telephone networks.

The system can also provide both for the benefit a user/Consumer and the benefit of a service Provider for a remarks or special needs that can be made in conjunction with the scheduling of a specific appointment.

The instant invention has been shown and described herein in what is considered to be the most practical and preferred embodiment. It is recognized, however, that departures may be made therefrom within the scope of the invention and that obvious modifications will occur to a person skilled in the art.

Thus, the overall purpose of this invention is to fully exploit internet/computerized advantages to quickly sort, select and optimally schedule a Consumer top receive service from Providers. Finally, Providers benefit from am efficient scheduling system which increases their revenues by filling open appointments in their schedule, as well as bring new Consumers to their business.

What is claimed is:

1. A system for finding, selecting and scheduling time appointments and providing for a plurality of users seeking specific services and a list of service Providers in a geographical area accessible by said user and service Provider comprising:
data base means associated with one or more Servers for storing service Provider profiles and calendar information of open slot times of availability for services and service Providers in a geographical area;
user PC access means for Consumer/Patient accessing said data base for selecting a service Provider and requesting an appointment at a specific time slot from a specific service Provider directed to said service Provider”s PC access;
service Provider reply means for notifying said user requesting an appointment of approval or disapproval of said time slot;
user data collection means for transmitting user data to said service Provider with time slot appointment request;
application program maintained on a (Host) Server for scheduling for comparing different variables of information related to a group of service Providers within a specific service geographical area including the “first available” time slot, distance from user; and
user confirmation includes means for notifying said user that the service Provider has accepted the appointment at the designated time requested by the user, or not.

2. A system as in claim 1, including user means for prepaying services prior to arriving at said appointment by said user to a service Provider during the scheduling of the appointment, and after insurance/payment coverage has been verified via email on web.

3. A system as in claim 1, including:
means for providing said user from a Server data base a visual calendar display for each service Provider selected showing open time slots indicating availability of time for appointments.

4. An interactive Consumer user service Provider schedule for efficiently matching a user, Consumer, client or patient with a service Provider that includes a centralized web domain portal Hosting thousands of individual service Provider work schedules comprising the steps of:
providing a Host scheduler Server that includes application programs for interactive scheduling Consumers and service Providers and a Server Provider data base listing the plurality of service Providers by the services;
providing the Host scheduler data base(or server) including home website available for internet access by Consumers, users and service Providers;
displaying a user Consumer menu that allows for specific services to be available in a geographical location accessible by the user;
providing a plurality of individual service Providers capable of providing a specific service once the service is selected by a user for selection by an individual;
providing the user menu with selected variables including first available, distance from user;
providing a calendar of a selected service Provider that includes a daily and time of day open slot availability of the service Provider accessible by the user Consumer;
notifying a service Provider that a particular user has requested an appointment at the service Provider”s own PC display; and
allowing the service Provider to email the user of the acceptance or non-acceptance, or pending status of the user's desired appointment by email.
